(19) United States
(12) Patent Application Publication
(10) Pub. No.: US 2004/0123646 A1
(43) Pub. Date: Jul. 1, 2004

(54) Gas permeability measurement method and gas permeability measurement device

(75) Inventors: Noriyasu Echigo, Hyogo (JP); Hideki Okumura, Nara (JP); Hiroshi Satani, Kyoto (JP)

Correspondence Address: McDERMOTT, WILL & EMERY, 600 13th Street, N.W., Washington, DC, 20005-3096, US

(73) Assignee: MATSUSHITA ELECTRIC INDUSTRIAL CO., LTD

(21) Appl. No.: 10/732,288

(22) Filed: Dec. 11, 2003

(30) Foreign Application Priority Data
Dec. 25, 2002 (JP) P2002-374310

(51) Int. Cl. G01N 15/08

(52) U.S. Cl. 73/38

(57) ABSTRACT

In a gas permeability measurement method according to the present invention, an isotopic gas having a mass number different to that of a target gas for measurement is introduced into one of two spaces divided by a test piece, and the isotopic gas having permeated the test piece and transferred to another space is detected to thereby measure the permeability of the target gas.

### FIELD OF THE INVENTION

The present invention relates to a gas permeability measurement method and a gas permeability measurement device utilized for measuring gas permeability of, for example, plastic film, sheet, converted paper and the like.

### BACKGROUND OF THE INVENTION

In the process of selecting packaging, agricultural and electric materials and the like for a variety of uses, permeability of gas such as oxygen, water vapor or the like is conventionally measured.

In the case of the packaging material, for example, the rate of oxygen permeability is important for quality maintenance because it directly impacts on an object packaged in terms of oxidization of the elements and change of the color tone and scent. That is why the permeability of gas, such as oxygen or the like, is measured when the packaging material is selected.

In measuring the gas permeability (permeation rate) of oxygen, water vapor and the like with respect to the plastic film, sheet and the like, the gas permeation rate test method JIS K 7126 or the water vapor permeation rate test method JIS K 7129 is generally employed.

FIG. 3 is a simplified block diagram of a gas permeation rate measurement device according to the foregoing JIS K 7126.

In FIG. 3, 110 is a permeation cell, as a test vessel, for permeating gas through a test piece 100 which is installed therein, 160′ is a pressure detector for detecting a pressure variation caused by the permeated gas, 155 is a test gas introducer for supplying the permeation cell 110 with the gas, 150′ is a test gas cylinder, 116 is a vacuum pump, and 122 through 125 are stop valves.

The test piece 100 is superimposed on a filter paper 105 and then arranged to be sandwiched between an upper cell 110a and a lower cell 110b of the permeation cell 110, on the upper and lower sides of which a hyperbaric chamber 140 and a hypobaric chamber 135 are respectively formed.

To begin with, the vacuum pump 116 is activated to first evacuate the hypobaric chamber 135 of the permeation cell 110 and then evacuate the hyperbaric chamber 140 of the permeation cell 110. The evacuation of the hypobaric chamber 135 is terminated, and the vacuum thereof is maintained.

Next, a test gas is introduced by approximately one atm into the hyperbaric chamber 140 of the permeation cell 110, and the pressure of the hyperbaric chamber 140 when the foregoing is conducted is recorded. The pressure of the hypobaric chamber 135 starts to rise, and the permeation of the gas is confirmed. The gas permeation rate or gas permeation coefficient is calculated from a measured tilt of the straight part of a permeation curved line by means of a predetermined formula.

In the foregoing conventional gas permeability measurement method, however, when measuring the permeability of gas existing in the natural world such as oxygen, water vapor and the like, it is not possible to determine if the gas in the hypobaric chamber 135 has permeated the test piece 100, remained in the permeation cell 110 and the like, or adsorbed to the test piece 100. Thus, there is a limit to pursuing highly accurate measurement of gas permeability.

In particular, it is presently very difficult to measure gas permeability in the case of test materials of very low gas permeability such as a vacuum heat insulation material, a seal film for organic EL display and the like.

### SUMMARY OF THE INVENTION

Therefore, a main object of the present invention is to provide a gas permeability measurement method and a gas permeability measurement device capable of measuring gas permeability with very little impact or affect from gas existing in the natural world.

In the gas permeability measurement method according to the present invention, gas permeability of a test piece is measured. Into one of two spaces divided by the test piece is introduced an isotopic gas having a mass number different to that of a gas targeted for measurement of the gas permeability. The gas permeability of the isotopic gas having permeated the test piece and transferred to another space is detected to thereby measure the permeability of the target gas.

In the gas permeability measurement device according to the present invention, gas permeability of a test piece is measured. The gas permeability measurement device comprises a test vessel having two spaces divided by the test piece, an isotopic gas supply source for supplying one of the spaces of the test vessel with an isotopic gas having a mass number different to that of a gas targeted for measurement of the gas permeability, and a mass spectrometer for detecting the isotopic gas having permeated the test piece and transferred to another space.

According to the present invention, an isotopic gas having a mass number different to that of a gas targeted for measurement, rarely found in the natural world and of chemical property identical to that of the target gas is used. This enables the isotopic gas to be detected as the gas having permeated the test piece, which can be separated from any gas frequently found in the natural world and therefore detected without any impact therefrom.

### BRIEF DESCRIPTION OF THE DRAWINGS

These and other objects as well as advantages of the invention will become clear by the following description of preferred embodiments of the invention with reference to the accompanying drawings, wherein:

FIG. 1 is a simplified block diagram of a gas permeability measurement device according to an Embodiment 1 of the present invention.

FIG. 2 is a simplified block diagram of a gas permeability measurement device according to an Embodiment 2 of the present invention.

FIG. 3 is a simplified block diagram of a conventional product.

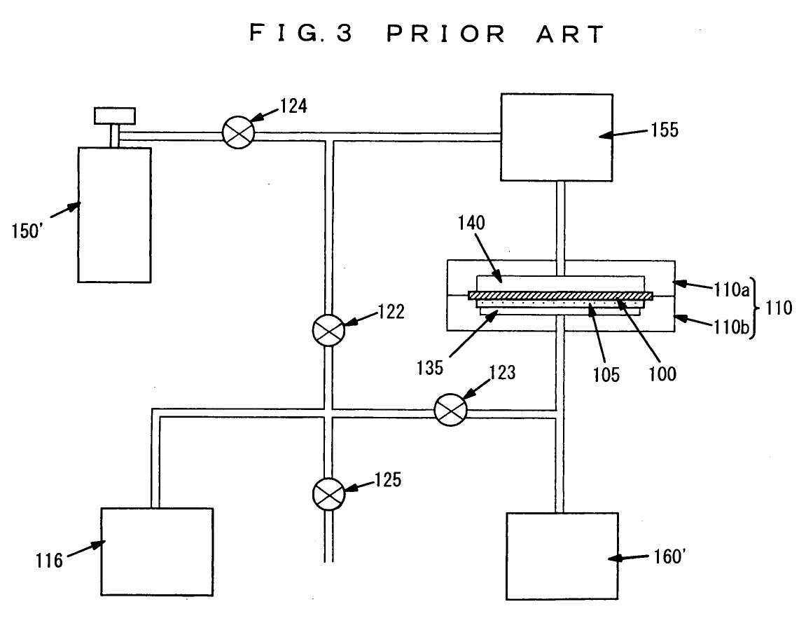

In all these figures, like components are indicated by the same numerals

### DETAILED DESCRIPTION OF THE PREFERRED EMBODIMENTS

Embodiments of the present invention are hereinafter described in detail referring to the drawings.

(Embodiment 1)

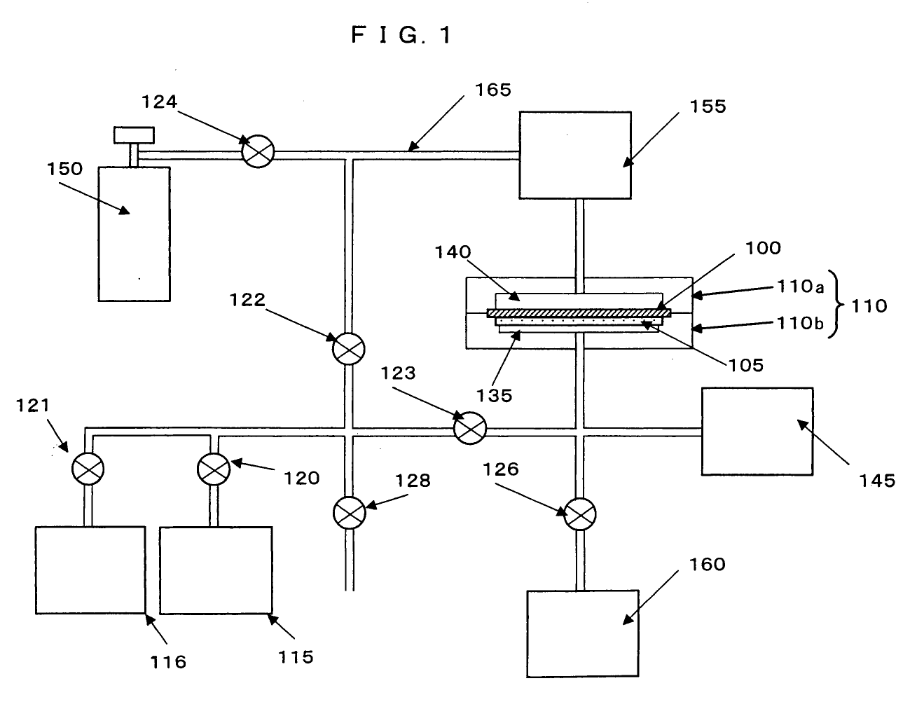

FIG. 1 is a simplified block diagram of a gas permeability measurement device used for implementation of a gas permeability measurement method according to an Embodiment 1 of the present invention. In this embodiment, the device and method are applied to the permeability measurement of oxygen, the description of which follows.

The gas permeability measurement device according to this embodiment comprises a permeation cell 110, as a test vessel in which a test piece 100 of sheet type such as plastic film is installed, a gas cylinder 150, as an isotopic gas supply source, filled with an isotopic gas ¹⁷O₂ made of atomies having a mass number of 17 different to that of a gas targeted for permeability measurement, that is oxygen ¹⁶O₂ made of atomies having a mass number of 16, a test gas introducer 155 for introducing the isotopic gas from the gas cylinder 150 into the permeation cell 110, a roughing vacuum pump 115 and a high vacuum pump 116 for vacuuming the permeation cell 110, a vacuum meter 145 for measuring a degree of vacuum and a detector 160 for detecting the isotopic gas having permeated the test piece 100. These are connected by a required pipe arrangement 165 having stop valves 120 through 124 and 126 and a leak valve 128 interposed therein.

In the gas permeability measurement method according to this embodiment, the test piece 100 of sheet type such as plastic film is superimposed on a filter paper 105, the periphery of which is sandwiched between an upper cell 110a and a lower cell 10b of the permeation cell 110. Around the portion sandwiching the test piece 100 of the permeation cell 110 is provided a vacuum seal mechanism such as an O-ring (not shown). In the foregoing arrangement, a hyperbaric chamber 140 on the upper side and a hypobaric chamber 135 on the lower side, which are two spaces divided by the test piece 100, are formed.

Next, the roughing vacuum pump 115 is activated with the respective valves 120 through 124, 126 and 128 previously closed, and the stop valves 120 and 123 are opened to evacuate the hypobaric chamber 135 on the filter-paper-105 side of the permeation cell 110. The stop valve 122 is then opened to evacuate the hyperbaric chamber 140, which is the opposite space in the permeation cell 110 across the test piece 100.

To further enhance the degree of vacuum, the stop valve 120 is closed, the high vacuum pump 116 is activated and the stop valve 121 is opened to evacuate the hypobaric chamber 135 and hyperbaric chamber 140 to the high vacuum level. The high vacuum means, for example, vacuum degree of more than 10⁻¹ Pa. In this embodiment, for example, the evacuation is executed to reach the vacuum degree of approximately 10⁻⁴ Pa at most. The vacuum degree is measured by the vacuum meter 145.

To measure the permeability with high accuracy eliminating the impact from gas remaining in or adsorbed to the test piece 100 and the permeation cell 110, it is desirable, as described, to evacuate the hypobaric and hyperbaric chambers 135 and 140 of the permeation cell 110 to the high vacuum level. The high vacuum evacuation maybe, however, included in another embodiment of the present invention, and may be omitted here.

As a further step, having closed the stop valve 122, the stop valve 124 is opened, and the gas flow from the gas cylinder 150 filled with the isotopic gas ¹⁷O₂ of the oxygen ¹⁶O₂ to be measured is adjusted by the test gas introducer 155. The isotopic gas is introduced so that the pressure of the hyperbaric chamber 140 of the permeation cell 110 is arranged to be one atm. The stop valve 126 is opened at the time of introducing the isotopic gas, and the volume of the isotopic gas having permeated the test piece 100 is measured by the detector 160.

A mass spectrometer is used as the detector 160 to thereby detect the mass number of the permeated isotopic gas. A variation of the detected value around the time of introducing the isotopic gas is measured, based on which the gas permeability is calculated.

The gas permeability is calculated, for example, as follows. The detected value by the detector 160, that is the mass spectrometer, is outputted as an ion current value, which is required to be converted into the permeability. For that purpose, with respect to the same test piece, the permeability is measured according to the previously cited conventional method standardized in JIS, while being measured according to this embodiment. Based on a relationship between these differently measured values is predetermined a conversion coefficient and conversion formula for converting the measured value according to this embodiment into the permeability.

According to the predetermined formula and the like, the detected value by the detector 160 is converted into the permeability, which constitutes the permeability of the oxygen ¹⁶O₂.

As described, the permeability is measured by using the isotopic gas ¹⁷O₂ rarely found in the natural world and having the chemical property identical to that of the oxygen ¹⁶O₂ targeted for measurement. Thus, the measurement step is separated from the oxygen ¹⁶O₂, which is often found in the natural world, remaining in the test vessel of the permeation cell 110 and the like and adsorbed to the test piece 100, and therefore undergoes no impact from such. This, therefore, results in the highly accurate measurement of the permeability of the oxygen ¹⁶O₂.

Specifically, when the hypobaric and hyperbaric chambers 135 and 140 of the permeation cell 110 are previously evacuated to the high vacuum level, the volume of the oxygen ¹⁶O₂ remaining in the test vessel of the permeation cell 110 and the like and adsorbed to the test piece 100 is reduced to thereby enable measurement of higher accuracy.

In this embodiment, the isotopic gas ¹⁷O₂ is used. However, an isotopic gas ¹⁸O₂ made of oxygen atomies having the mass number of 18 may be used as another embodiment of the present invention, or an isotopic gas with both of ¹⁷O₂ and ¹⁸O₂ combined may also be used.

The test piece 100 is not limited to the sheet type and may be a film type.

(Embodiment 2)

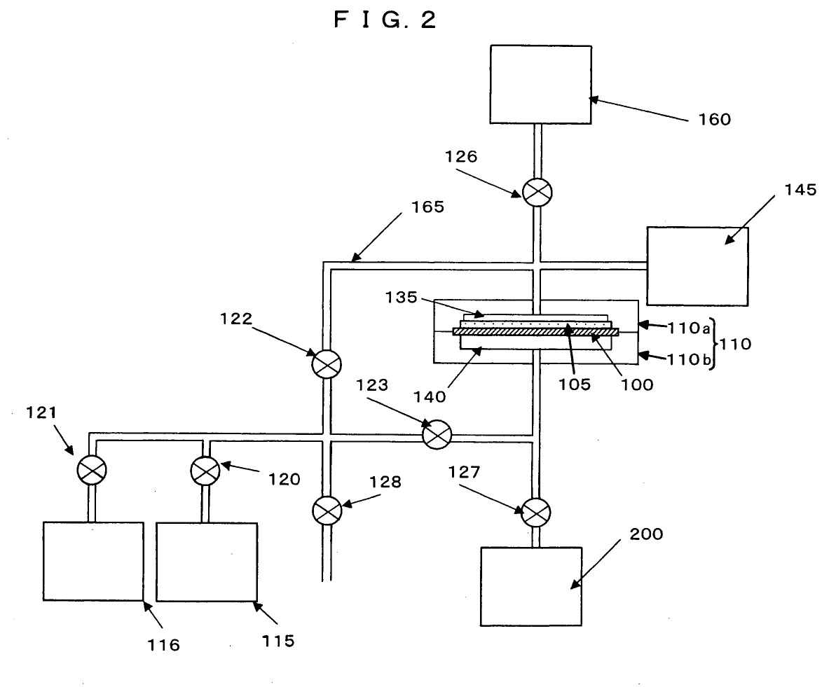

FIG. 2 is a simplified block diagram of a gas permeability measurement device used for implementation of a gas permeability measurement method according to an Embodiment 2 of the present invention. The portions corresponding the foregoing FIG. 1 are provided with the same reference numerals. In this embodiment, the device and method are applied to the permeability measurement of water vapor, the description of which follows.

According to the gas permeability measurement device of this embodiment, a water vapor generator 200, in place of the gas cylinder 150 and a test gas introducer 155 of the Embodiment 1, for generating vapor of heavy water D₂O having the mass number of 20, which is an isotopic gas of water vapor H₂O having the mass number of 18 to be measured, is provided.

In this embodiment, the lower side with respect to a test piece 100 is a hyperbaric chamber 140, and the upper side with respect thereto is a hypobaric chamber 135. This configuration is arranged to be reverse to that of FIG. 1 according to the Embodiment 1 so that condensed dew does not remain in the test piece 100 and return to the water vapor generator 200 when the hyperbaric chamber 140 is maintained at a moisture level close to a saturated vapor pressure.

According to the gas permeability measurement method of this embodiment, a filter paper 105 is superimposed on a test piece 100, and the periphery thereof is arranged to be sandwiched between an upper cell 110a and a lower cell 110b of a permeation cell 110. Around the portion sandwiching the test piece 100 of the permeation cell 110 is provided a vacuum seal mechanism such as an O-ring (not shown) as described in the Embodiment 1.

Next, a roughing vacuum pump 115 is activated with respective valves 120 through 123 and 126 through 128 previously closed, and the stop valves 120 and 122 are opened to evacuate the hypobaric chamber 135. Then, the stop valve 123 is opened to evacuate the hyperbaric chamber 140. To further enhance the degree of vacuum, the stop valve 120 is closed, a high vacuum pump 116 is activated and the stop valve 121 is opened to evacuate the hypobaric chamber 135 and hyperbaric chamber 140 to the vacuum degree of, for example, at most 10⁻⁴ Pa. The vacuum degree is measured by a vacuum meter 145.

The water vapor generator 200 is filled with the heavy water D₂O, and the vapor of the heavy water D₂O, which is the isotopic gas, is maintained at a saturated vapor pressure. Stop valves 126 and 127 are simultaneously opened, and the vapor volume of the heavy water D₂O having permeated the test piece 100 is measured by a detector 160.

Because the permeation cell 110 is evacuated to the high vacuum level before the test piece 100 is exposed to the vapor, water molecules adsorbed to the permeation cell 110 and the test piece 100 are adequately reduced and the volume of the heavy water D₂O contained in the discharged gas is made ignorably small. Therefore, the detected level by the detector 160 of the heavy water D₂O having the mass number of 20 is below a detection limit.

After the evacuation to the high vacuum level, the vapor of the heavy water D₂O is introduced into the hyperbaric chamber 140. Upon the time of the introduction, the heavy water D₂O having the mass number of 20 is detected by the detector 160. Thus, the volume of the permeated water molecules, based on a variation of the detected value around the time of introducing the heavy water D₂O, is calculated according to a predetermined formula as in the Embodiment 1.

As described, the heavy water D₂O, which is rarely found in the natural world, is arranged to permeate the test piece 100 and the evacuation is executed to the high vacuum level so that the permeated heavy water D₂O alone is detected. In this manner, the permeability is measured with no impact from the water vapor remaining in the permeation cell 110 and adsorbed to the test piece 100.

There were described the foregoing embodiments referring to the permeability measurement of oxygen and water vapor. The present invention, however, can be applied to the permeability measurement of, for example, such gasses as carbon monoxide, carbon dioxide, methane or the like. In such cases, an isotopic gas containing, for example, heavy water 2H having the mass number of 2 or carbon ¹³C having the mass number of 13 is used.

As thus far described, in the present invention, the gas permeability is measured with high accuracy by using an isotopic gas having a mass number different to that of a gas targeted for measurement, rarely found in the natural world and of chemical property identical to that of the target gas. Therefore, the gas permeability is easily measured in the case of, for example, materials of very low gas permeability exemplified by vacuum heat insulation material used in refrigerators, a seal material or a seal film for organic EL display and the like.

While there has been described what is at present considered to be preferred embodiments of this invention, it will be understood that various modifications may be made therein, and it is intended to cover in the appended claims all such modifications as fall within the true spirit and scope of this invention.

What is claimed is:

1. A gas permeability measurement method for measuring gas permeability through a test piece, wherein
an isotopic gas having a mass number different to that of a gas targeted for measurement is introduced into one of two spaces divided by the test piece, and
the isotopic gas having permeated the test piece and transferred to another space is detected to thereby measure the permeability of the target gas.

2. A gas permeability measurement method for measuring gas permeability as claimed in claim 1, wherein
the another space is vacuumized to thereby measure a mass of the isotopic gas by a mass spectrometer.

3. A gas permeability measurement method for measuring gas permeability as claimed in claim 1, wherein
the gas targeted for measurement is oxygen ¹⁶O₂, and the isotopic gas is at least one of ¹⁷O₂ and ¹⁸O₂.

4. A gas permeability measurement method for measuring gas permeability as claimed in claim 2, wherein
the gas targeted for measurement is oxygen ¹⁶O₂, and the isotopic gas is at least one of ¹⁷O₂ and ¹⁸O₂.

5. A gas permeability measurement method for measuring gas permeability as claimed in claim 1, wherein
the gas targeted for measurement is water vapor, and the isotopic gas is vapor of heavy water.

6. A gas permeability measurement method for measuring gas permeability as claimed in claim 2, wherein
the gas targeted for measurement is water vapor, and the isotopic gas is vapor of heavy water.

7. A gas permeability measurement method for measuring gas permeability as claimed in claim 1, wherein
the two spaces are formed in a test vessel by having the test piece installed in the test vessel, and the test-piece-installed test vessel is previously evacuated to a high vacuum level.

8. A gas permeability measurement device for measuring gas permeability through a test piece characterized in comprising:
a test vessel having two spaces divided by the test piece;
an isotopic gas supply source for supplying one of the two spaces with an isotopic gas having a mass number different to that of a gas targeted for measurement; and
amass spectrometer for detecting the isotopic gas having permeated the test piece and transferred to another space of the test vessel.
